(19) United States
(12) Patent Application Publication
(10) Pub. No.: US 2020/0089496 A1
(43) Pub. Date: Mar. 19, 2020

(54) ARITHMETIC PROCESSING DEVICE, INFORMATION PROCESSING APPARATUS, AND METHOD FOR CONTROLLING ARITHMETIC PROCESSING DEVICE

(71) Applicant: FUJITSU LIMITED, Kawasaki-shi (JP)

(72) Inventor: Masanori Higeta, Setagaya (JP)

(73) Assignee: FUJITSU LIMITED, Kawasaki-shi (JP)

(21) Appl. No.: 16/689,147

(22) Filed: Nov. 20, 2019

Related U.S. Application Data
(62) Division of application No. 15/910,029, filed on Mar. 2, 2018.

(30) Foreign Application Priority Data
Mar. 28, 2017 (JP) 2017-063026

(51) Int. Cl. G06F 9/30; G06F 11/00; G06F 15/80

(52) U.S. Cl. CPC G06F 9/30043; G06F 11/00; G06F 15/80; G06F 9/30032; G06F 15/8007

(57) ABSTRACT

An arithmetic processing device includes: a memory controller that accesses a main storage device; a plurality of arithmetic processing cores that execute instructions; an instruction controller that controls execution of an access instruction to load and store data in the plurality of arithmetic processing cores from and to the main storage device; and a transfer controller that controls data transfer between the memory controller and the plurality of arithmetic processing cores in accordance with an instruction from the instruction controller.

### CROSS-REFERENCE TO RELATED APPLICATION

This application is a division of application Ser. No. 15/910,029, filed Mar. 2, 2018, which is based upon and claims the benefit of priority of the prior Japanese Patent Application No. 2017-63026, filed on Mar. 28, 2017, the entire contents of which are incorporated herein by reference.

### FIELD

The embodiments discussed herein are related to an arithmetic processing device, an information processing apparatus, and a method for controlling the arithmetic processing device.

### BACKGROUND

With respect to a multicore architecture, in which a single processor includes a plurality of processor cores (hereinafter referred to as “cores”) as arithmetic processing units, a method is known in which an execution control unit that executes memory load and store instructions and an execution control unit that executes processing instructions are provided for each core and reading (loading) of data from a main memory, writing (storing) of data to the main memory, and arithmetic processing is performed for each core.

Japanese Laid-open Patent Publication No. 5-101207 and Japanese Laid-open Patent Publication No. 2007-148709 disclose examples of the related art.

### SUMMARY

According to an aspect of the embodiments, an arithmetic processing device includes: a memory controller that accesses a main storage device; a plurality of arithmetic processing cores that execute instructions; an instruction controller that controls execution of an access instruction to load and store data in the plurality of arithmetic processing cores from and to the main storage device; and a transfer controller that controls data transfer between the memory controller and the plurality of arithmetic processing cores in accordance with an instruction from the instruction controller.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an information processing apparatus;

FIGS. 2A and 2B illustrate an example of an operation for accessing a memory performed by a processor;

FIGS. 3A and 3B illustrate examples of the operation for accessing the memory performed by the processor;

FIGS. 4A and 4B illustrate an example of the operation for accessing the memory performed by the processor;

FIG. 5 illustrates an example of an operation performed by the processor;

FIG. 6 illustrates an example of a process for accessing the memory;

FIG. 7 illustrates an example of a process for accessing the memory;

FIGS. 8A to 8C illustrate examples of an instruction code;

FIG. 9 illustrates an example of an information processing apparatus;

FIG. 10 illustrates an example of an instruction code;

FIG. 11 illustrates an example of an information processing apparatus;

FIGS. 12A to 12C illustrate an example of an operation for copying data using an instruction “copy”;

FIG. 13 illustrates an example of an operation performed by the information processing apparatus illustrated in FIG. 11;

FIG. 14 illustrates an example of an information processing apparatus;

FIGS. 15A to 15C illustrate an example of an operation for transferring data using an instruction “pushs”;

FIGS. 16A to 16C illustrate an example of an operation for transferring data using an instruction “pullm”;

FIGS. 17A to 17C illustrate an example of an operation for transferring data using the instruction “pushs”;

FIG. 18 illustrates an example of an operation performed by the information processing apparatus illustrated in FIG. 14;

FIG. 19 illustrates an example of an information processing apparatus;

FIG. 20 illustrates an example of an information processing apparatus;

FIG. 21 illustrates an example of an operation performed by the information processing apparatus illustrated in FIG. 20;

FIG. 22 illustrates an example of an information processing apparatus;

FIG. 23 illustrates an example of an operation performed by the information processing apparatus illustrated in FIG. 22;

FIG. 24 illustrates an example of a multicore processing device (processor);

FIGS. 25A to 25C illustrate an example of an operation at a time when a plurality of cores write data to a memory; and

FIGS. 26A to 26D illustrate an example of an operation at a time when the plurality of cores read data from the same address of the memory.

### DESCRIPTION OF EMBODIMENTS

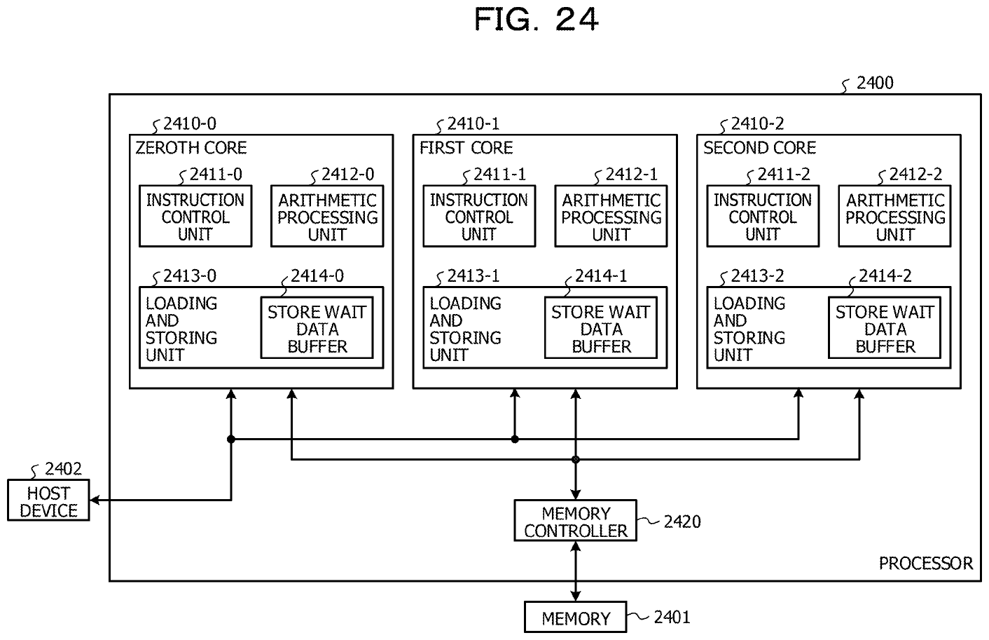

When the number of cores provided is large, for example, the cores are connected to a main memory through an access bus for the sake of convenience of installation of circuits. FIG. 24 illustrates an example of a multicore processing device (processor).

A processor 2400 illustrated in FIG. 24 includes a plurality of cores 2410 and a memory controller 2420. The cores 2410 each include an instruction control unit 2411 that controls instructions from a host device 2402, an arithmetic processing unit 2412 that performs arithmetic processing, and a loading and storing unit 2413 that reads and writes data from and to a memory 2401, which is a main storage device. The loading and storing unit 2413 includes a data buffer 2414 that holds data to be stored. The cores 2410 are connected, through a memory bus, to a memory controller 2420 that performs control relating to the memory 2401.

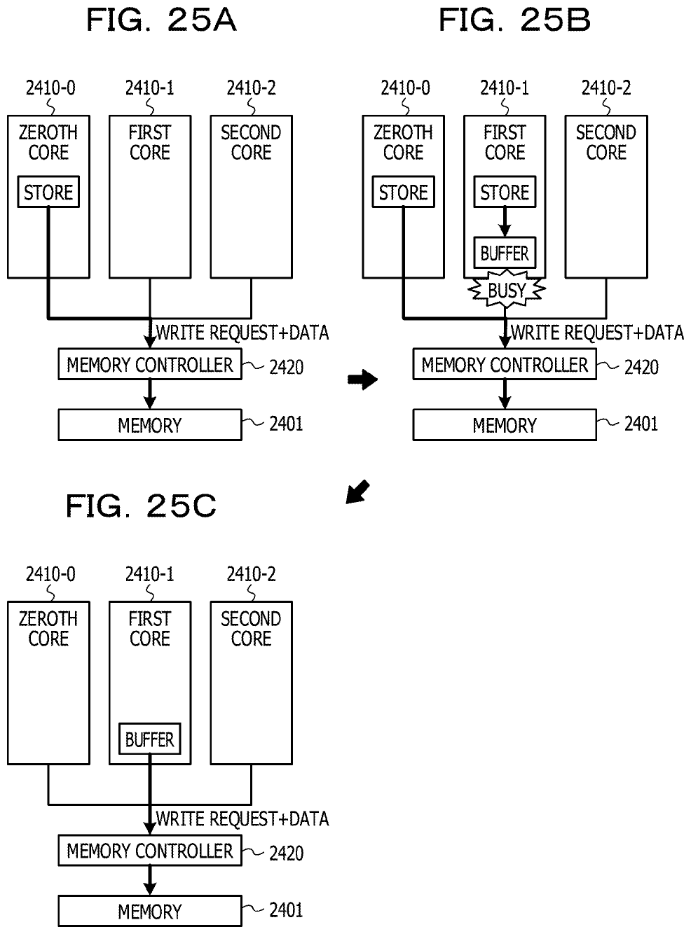

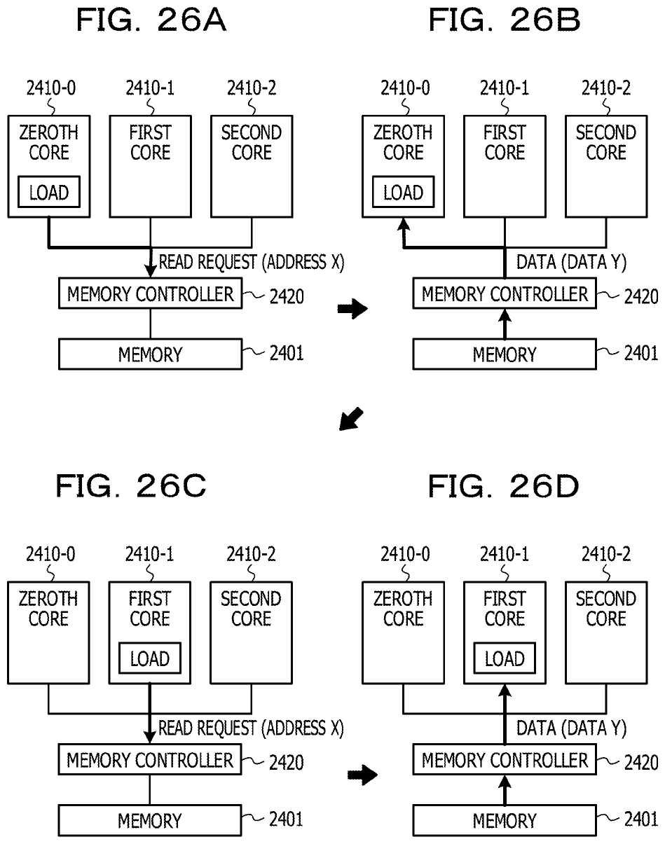

FIGS. 25A to 26D illustrate examples of an operation for accessing the memory 2401 performed by the processor 2400 illustrated in FIG. 24. FIGS. 25A to 25C illustrate an operation at a time when a plurality of cores write (store) data to the memory 2401 in parallel with each other. As illustrated in FIG. 25A, first, an instruction control unit 2411-0 of a zeroth core 2410-0 executes a store instruction, A loading and storing unit 2413-0 then transfers a write request and write data, which is a target of the write request, to the memory controller 2420 through the memory bus.

If a first core 2410-1 also executes a store instruction during the transfer, the first core 2410-1 tries to output a write request and write data to the memory bus as illustrated in FIG. 258. Since the zeroth core 2410-0 is already using the memory bus, however, the first core 2410-1 has to wait until the transfer is completed. After the data transfer performed by the zeroth core 2410-0 is completed, a loading and storing unit 2413-1 of the first core 2410-1 transfers the write request and the write data to the memory controller 2420 through the memory bus as illustrated in FIG. 25C. When a plurality of cores share a memory bus like this, each core has to include a data buffer 2414 for holding data until the memory bus becomes available.

FIGS. 26A to 26D illustrate an operation at a time when a plurality of cores read (load) data from the same address of the memory 2401 in parallel with each other. As illustrated in FIG. 26A, first, the instruction control unit 2411-0 of the zeroth core 2410-0 executes a load instruction, and the loading and storing unit 2413-0 transfers, to the memory controller 2420 through the memory bus, a read request relating to an address X. In response to the read request from the loading and storing unit 2413-0 of the zeroth core 2410-0, data Y is read from the memory 2401 and supplied to the zeroth core 2410-0 as illustrated in FIG. 26B.

If, as illustrated in FIG. 26C, the first core 2410-1 also requests the data Y at the address X and executes a load instruction after the above operation, a read request relating to the address X is issued to the memory controller 2420 again. In response to the read request from the first core 2410-1, the data Y is read from the memory 2401 again and supplied to the first core 2410-1 as illustrated in FIG. 26D. That is, even when a plurality of cores perform the same arithmetic processing and request the same data, each of the plurality of cores accesses a memory.

In the case of a processor in which a plurality of cores share a memory bus, for example, each core independently executes a memory access control instruction. A circuit for performing control such as bus mediation between cores and a data buffer for each core for holding write data in the case of bus contention, therefore, are provided, which increases the number of circuits. When a plurality of cores request the same data from a memory, for example, bus bands might be wasted. The increase in the number of circuits and the waste of bus bands become evident as the number of cores provided on a chip increases. An arithmetic processing device in which a plurality of cores share a memory bus and for which memory access performance is improved, for example, may be provided.

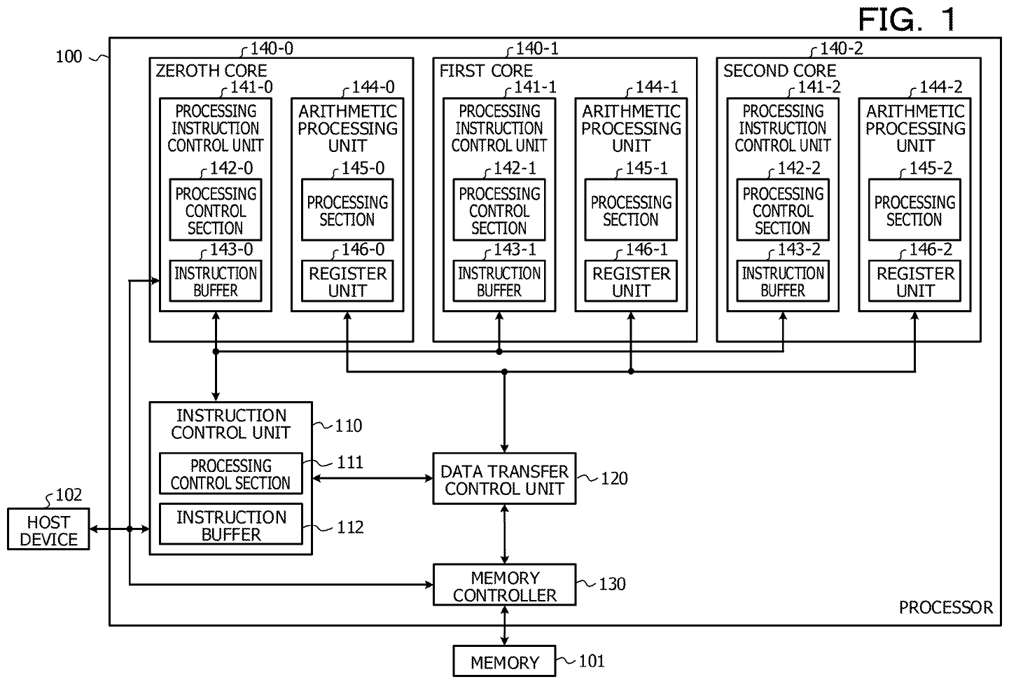

FIG. 1 illustrates an example of an information processing apparatus. The information processing apparatus includes a processor 100 as an arithmetic processing device and a memory 101 as a main storage device. The processor 100 performs processing operations in accordance with an instruction code supplied from a host device 102 communicably connected thereto.

The processor 100 includes an instruction control unit 110, a data transfer control unit 120, a memory controller 130, and a plurality of processor cores (hereinafter referred to as “cores”) 140. Although FIG. 1 illustrates an example in which the processor 100 includes three cores 140-0, 140-1, and 140-2, the processor 100 may include any number of cores.

The instruction control unit 110 controls processing operations performed by the processor 100 in accordance with instructions. The instruction control unit 110 collectively controls read instructions and write instructions issued, to the memory 101, by all the cores 140 included in the processor 100. That is, the instruction control unit 110 intensively controls memory access instructions issued by the cores 140 to the memory 101.

The instruction control unit 110 includes a processing control section 111 and an instruction buffer 112. The processing control section 111 obtains instructions from the instruction buffer 112 row by row, identifies operations to be performed based on the instructions, and issues instructions to relevant hardware resources. The processing control section 111 instructs the data transfer control unit 120 to perform an operation according to a read instruction or a write instruction issued to the memory 101 and a core 140 to perform an operation according to a processing instruction. The instruction buffer 112 stores an instruction code to be executed.

The data transfer control unit 120 controls data transfer between the memory controller 130 and the cores 140 in accordance with instructions from the instruction control unit 110. The data transfer control unit 120 and the cores 140 are connected to each other through a memory bus. The memory controller 130 as a memory control unit accesses the memory 101, for example, in accordance with a request from the data transfer control unit 120.

The data transfer control unit 120 receives, from the instruction control unit 110, an instruction (push instruction) to transfer data from the memory 101 to a core 140, issues a read request to the memory 101, and supplies data read in accordance with the read request to the core 140. The data transfer control unit 120 also receives, from the instruction control unit 110, an instruction (pull instruction) to transfer data from a core 140 to the memory 101, obtains data from the core 140, and issues, to the memory controller 130, a write request to the memory 101 in order to write the obtained data.

The cores 140 as arithmetic processing units that execute instructions each include a processing instruction control unit 141 that controls processing performed in accordance with processing instructions and an arithmetic processing unit 144 that performs processing according to processing instructions. The processing instruction control unit 141 includes a processing control section 142 and an instruction buffer 143. The processing control section 142 obtains instructions from the instruction buffer 143 row by row and instructs the arithmetic processing unit 144 to perform arithmetic processing in accordance with the instructions. The instruction buffer 143 stores an instruction code to be executed by the core 140.

The arithmetic processing unit 144 includes a processing section 145 that performs arithmetic processing and a register unit 146. The register unit 146 is a set of registers storing input data used for processing read from the memory 101 and result data obtained as a result of processing. In this example, the register unit 146 includes sixteen registers, namely zeroth to fifteenth registers, and each of the registers has a storage area of 4 bytes. In a first embodiment, instruction codes stored in the instruction buffers 112 and 143 are supplied from the host device 102.

As an instruction set handled by the instruction control unit 110, the following instructions “push”, “pull”, “exec”, “wait”, and “halt” are defined.
push <memory address><register number><core number>

The instruction “push” is used to read 4-byte data from a specified memory address and write the 4-byte data to a specified register of a specified core.
pull <memory address><register number><core number>

The instruction “pull” is used to read 4-byte data from a specified register of a specified core and write the 4-byte data to a specified memory address.
exec <code number><core number>

The instruction “exec” is used to cause the processing instruction control unit 141 of a specified core to execute an instruction code having a specified code number.
wait <instruction type>

The instruction “wait” is used to wait without processing an instruction until a specified type of instruction issued prior to the instruction is completed.
halt

The instruction “halt” is used to end an instruction process and issue a completion notification to the host device 102.

As an instruction set handled by the processing instruction control unit 141, the following instructions “add”, “sub”, “mul”, “jmp”, and “halt” are defined.
add <register number 1><register number 2><register number 3>

The instruction “add” is used to add data regarding two registers specified by register numbers 1 and 2 and write a result to a register specified by register number 3
sub <register number 1><register number 2><register number 3>

The instruction “sub” is used to subtract data regarding a register specified by register number 2 from data regarding a register specified by register number 1 and write a result to a register specified by register number 3
mul <register number 1><register number 2><register number 3>

The instruction “mul” is used to multiply data regarding two registers specified by register numbers 1 and 2 and write a result to a register specified by register number 3
jmp <register number><row number>

The instruction “jmp” is used, when a data value stored in a specified register is equal to or larger than 0, to execute an instruction in a specified row and, when the data value stored in the specified register is smaller than 0, to execute an instruction in a next row without moving to the specified row.
halt

The instruction “halt” is used to end an instruction process and issue a completion notification to the instruction control unit 110.

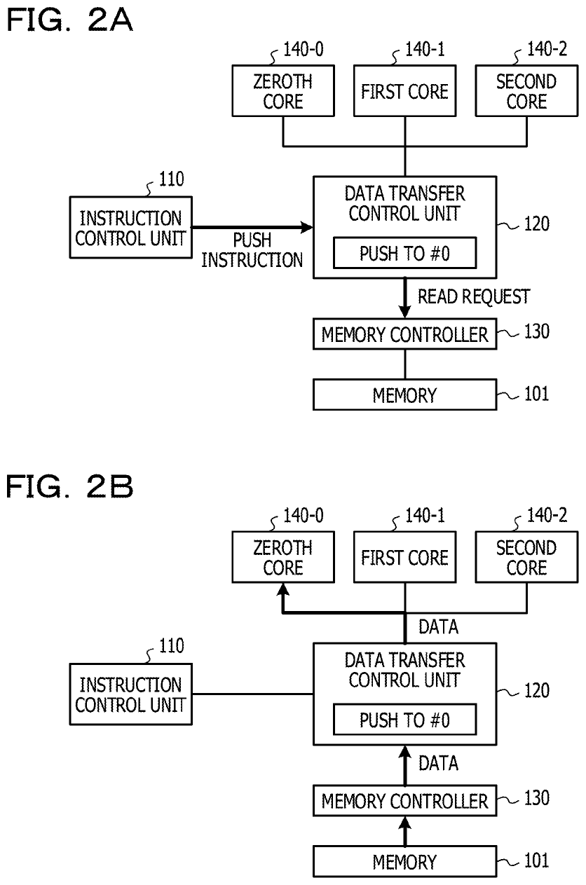

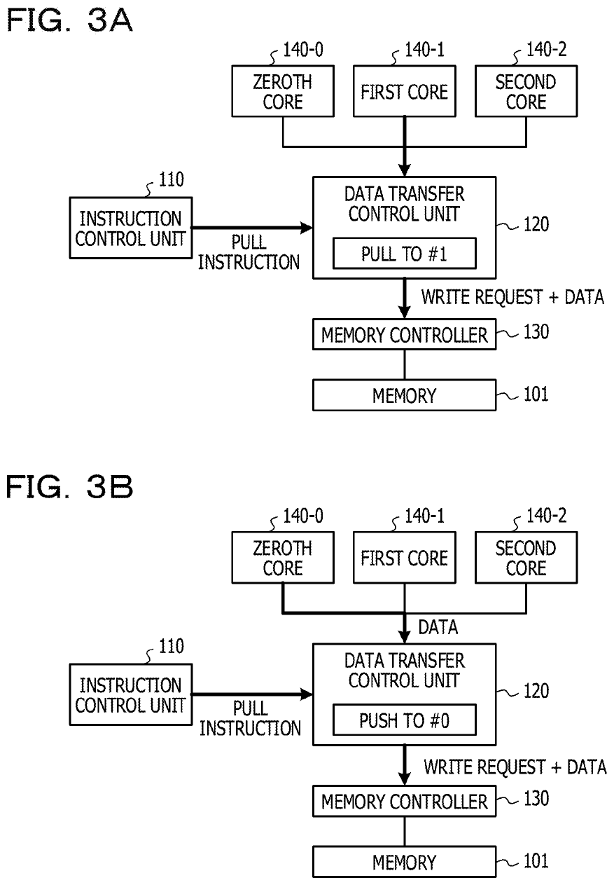

FIGS. 2A to 48 illustrate examples of an operation for accessing the memory 101 performed by the processor 100. The same components as those illustrated in FIG. 1 are given the same reference numerals. FIGS. 2A to 3B illustrate an operation performed by the instruction control unit 110 to control transfer of memory data to a core 140. As illustrated in FIGS. 2A and 2B, first, the instruction control unit 110 executes a push instruction to the zeroth core 140-0. In response to this, the data transfer control unit 120 issues a read request to the memory 101 to obtain data and transfers (pushes) the data to the zeroth core 140-0.

As illustrated in FIG. 3A, the instruction control unit 110 executes a pull instruction to the first core 140-1. In response to this, the data transfer control unit 120 obtains (pulls) data from the first core 140-1 and issues a write request to the memory 101 to write the data to the memory 101. In addition, as illustrated in FIG. 3B, the instruction control unit 110 executes a pull instruction to the zeroth core 140-0. In response to this, the data transfer control unit 120 obtains (pulls) data from the zeroth core 140-0 and issues a write request to the memory 101 to write the data to the memory 101.

By controlling the use of the memory bus singlehandedly using not the cores 140 but the instruction control unit 110, the cores 140 do not have to include data buffers for holding data in the case of bus contention, and the number of circuits can be reduced.

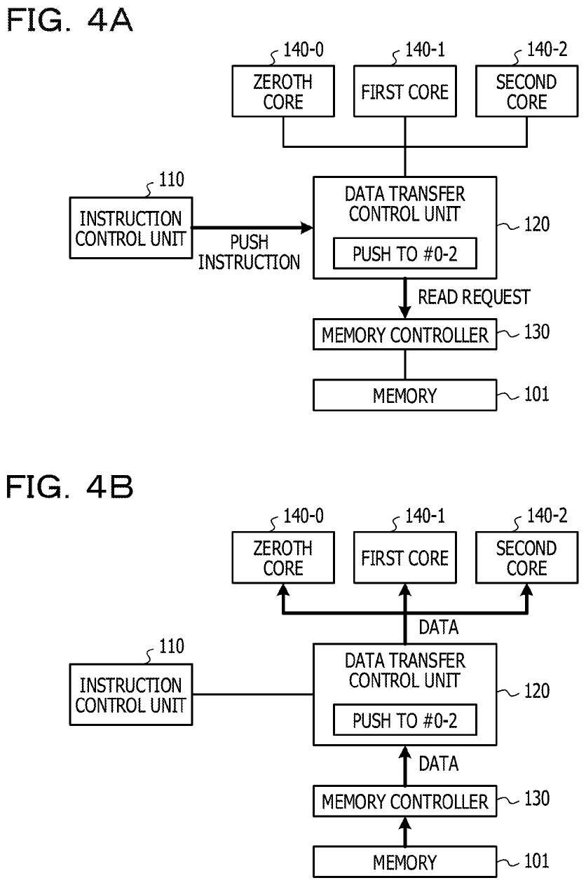

FIGS. 4A and 4B illustrate an operation performed by the instruction control unit 110 to broadcast memory data to all the cores 140. As illustrated in FIG. 4A, the instruction control unit 110 executes a push instruction to broadcast memory data to the zeroth to second cores 140-0 to 140-2. In response to this, the data transfer control unit 120 issues a read request to the memory 101. As illustrated in FIG. 4B, the data transfer control unit 120 obtains data in response to the read request to the memory 101 and transfers the data to the zeroth to second cores 140-0 to 140-2, By executing an instruction to broadcast data requested by all the cores 140, each of a plurality of cores does not have to access the same data, and throughput improves in the present embodiment.

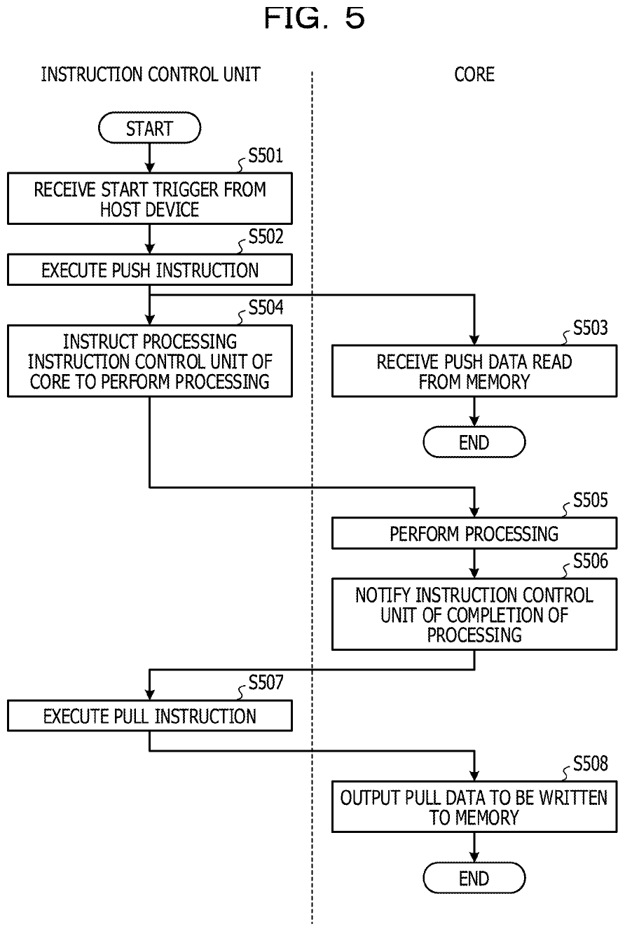

FIG. 5 illustrates an example of an operation performed by the processor 100. FIG. 5 is a flowchart illustrating an example of an operation performed until a series of processing steps is completed after the processor 100 receives a processing start notification from the host device 102. The instruction control unit 110 of the processor 100 receives a start trigger from the host device 102 (S501) and sequentially executes a push instruction and a pull instruction managed thereby.

The instruction control unit 110 instructs the data transfer control unit 120 to execute the push instruction described in an instruction code in order to read data from the memory 101 and transfer the read data to a destination core 140 (S502). The core 140 receives the data (push data) transferred from the data transfer control unit 120 (S503).

After executing the push instruction, the instruction control unit 110 instructs the processing instruction control unit 141 of the core 140 to perform arithmetic processing (S504). The processing instruction control unit 141 that has received the instruction sequentially performs processing operations according to processing instructions managed thereby (S505) and, after all the processing operations are completed, transmits a completion notification to the instruction control unit 110 (S506). Upon receiving the response from the core 140, the instruction control unit 110 instructs the data transfer control unit 120 to execute the pull instruction (S507), and the register unit 146 of the core 140 writes a result of the processing operations to the memory 101 (S508).

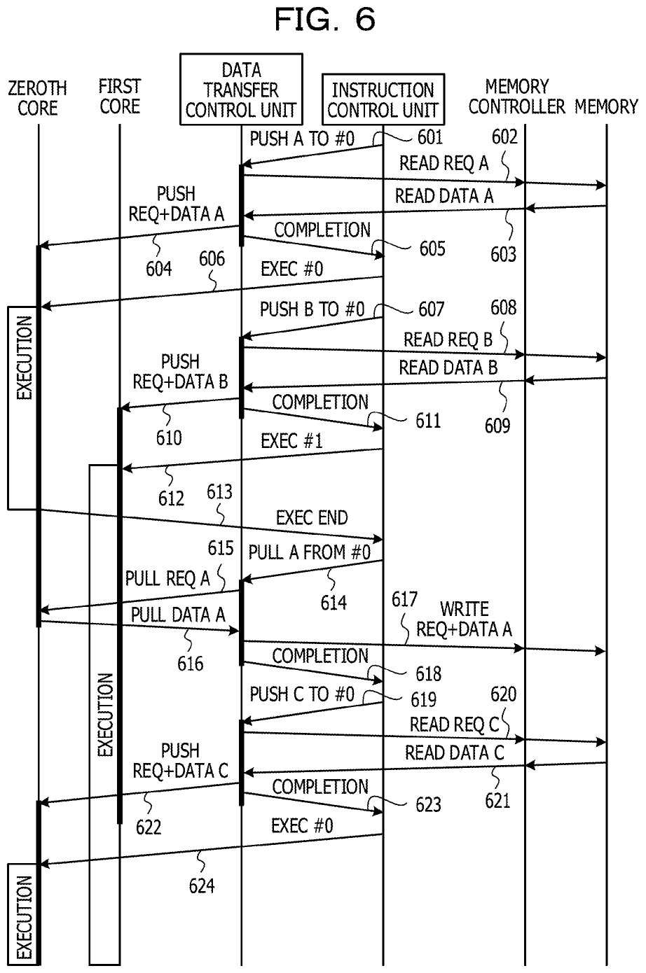

FIG. 6 illustrates an example of a process for accessing the memory 101. FIG. 6 illustrates a procedure in which the instruction control unit 110 supplies relevant processing instructions and data to the zeroth and first cores 140-0 and 140-1, executes an exec instruction to cause the zeroth and first cores 140-0 and 140-1 to execute processing instructions, waits for processing completion notifications from the zeroth and first cores 140-0 and 140-1, obtains result data, and writes the result data to the memory 101.

The instruction control unit 110 transmits a push instruction to the data transfer control unit 120 (601, 607, and 619), and the data transfer control unit 120 that has received the push instruction issues a read request to the memory 101 (602, 608, and 620). The data transfer control unit 120 receives read data from the memory 101 as a response to the read request (603, 609, and 621), transfers the data to the destination cores (604, 610, and 622), and transmits a completion notification to the instruction control unit 110 (605, 611, and 623).

Upon receiving the completion notification from the data transfer control unit 120, the instruction control unit 110 issues an exec instruction to cause the cores to execute processing instructions (606, 612, and 624). Upon receiving the exec instruction from the instruction control unit 110, the cores execute the processing instructions and, after processing operations are completed, transmit completion notifications to the instruction control unit 110 (613).

Upon receiving the completion notifications from the cores, the instruction control unit 110 issues a pull instruction to the data transfer control unit 120 (614). Upon receiving the pull instruction, the data transfer control unit 120 requests the cores to obtain results of the processing operations (615). The data transfer control unit 120 receives processing result data from the cores as a response to the request (616), writes the result data to the memory 101 (617), and transmits a completion notification to the instruction control unit 110 (618).

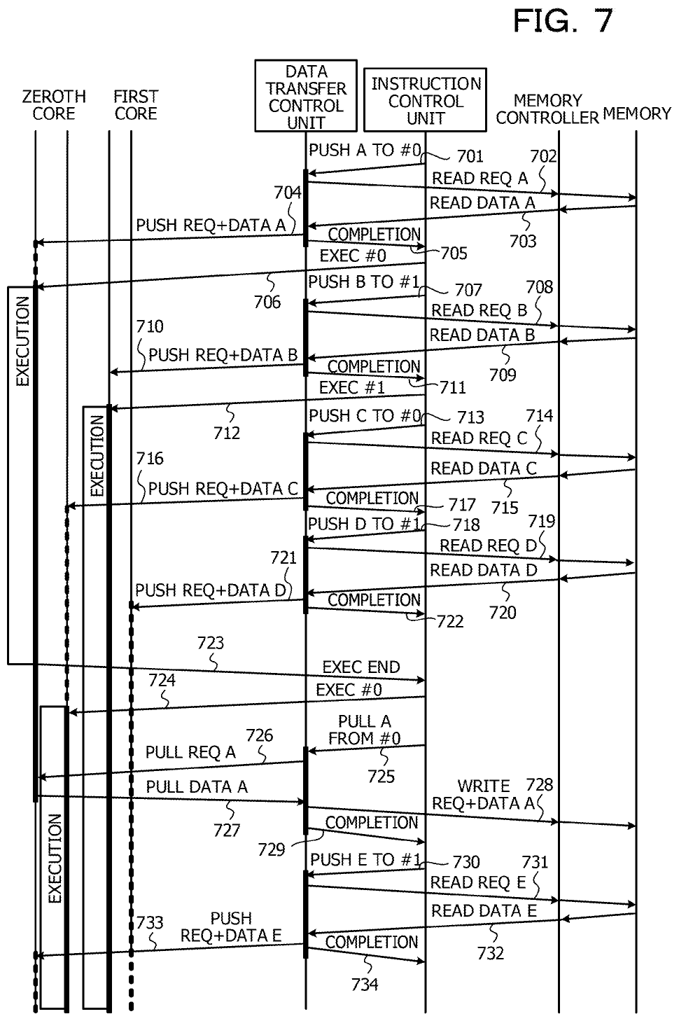

FIG. 7 illustrates an example of a process for accessing the memory 101. FIG. 7 illustrates an example in which a method for transferring data is modified in such a way as to improve operation rates of the processing sections 145 of the cores 140. In this example, control is performed while dividing a data storage area of each of the cores 140 into a part for performing processing and a part for prefetching.

For example, first, the instruction control unit 110 supplies data A to the processing storage area of the zeroth core 140-0 to start processing (701 to 706). Meanwhile, the instruction control unit 110 also supplies data C to the prefetching storage area of the zeroth core 140-0 (713 to 717). Similarly, the instruction control unit 110 supplies data D to the prefetching storage area of the first core 140-1 while performing processing for data B (718 to 722).

In addition, after the processing performed by the cores is completed, the instruction control unit 110 instructs, before obtaining result data, the zeroth and first cores 140-0 and 140-1 to start next processing operations (724). By obtaining results of previous processing operations and supplying data to be used in next processing operations while the cores are performing processing operations, the latency of memory access can be hidden in processing time, and the processing sections 145 can continue to operate without waiting for data to be supplied.

Although FIGS. 6 and 7 illustrate procedures in which the instruction control unit 110 issues instructions to the data transfer control unit 120 one by one and corresponding processing operations are performed one by one for the sake of simplicity, the procedure to be performed is not limited to this. More effective control can be performed when the instruction control unit 110 simultaneously issues a plurality of instructions to the data transfer control unit 120 and the data transfer control unit 120 has a function of a scheduler that issues push and pull instructions while switching the order of instructions such that a use rate of the memory bus becomes maximum.

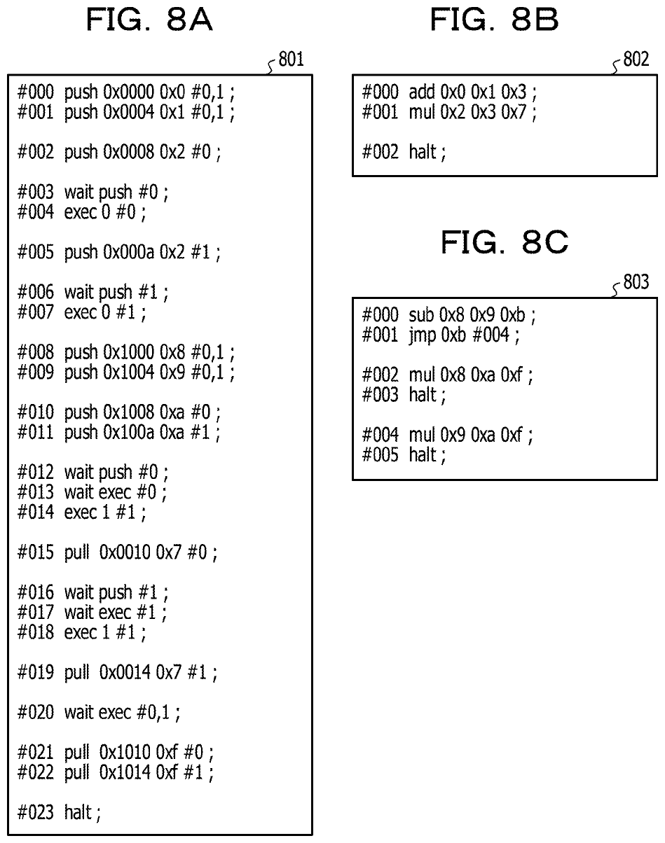

FIGS. 8A to 8C illustrate examples of an instruction code. In the following description, an instruction code to be executed by the instruction control unit 110 will be referred to as a “master instruction code”, and an instruction code to be executed by the processing instruction control unit 141 will be referred to as a “slave instruction code”,

FIG. 8A illustrates an example of a master instruction code to be executed by the instruction control unit 110. In this master instruction code, first, in #000 and #001, data at memory addresses 0x0000 and 0x0004 is read and then broadcast and written to registers of the zeroth and first cores 140-0 and 140-1 as a result of instructions “push”. Next, in #002, data at a memory address 0x0008 is written to a register of the zeroth core 140-0 as a result of an instruction “push”. In #003, completion of the instruction “push” to the zeroth core 140-0 is waited for, and in #004, the zeroth core 140-0 is instructed to execute a zeroth slave instruction code as a result of an instruction “exec”.

Similarly, in #005, data at a memory address 0x000a is written to the registers of the first core 140-1 as a result of an instruction “push”. In #006, completion of the instruction “push” is waited for, and in #007, the first core 140-1 is instructed to execute the zeroth slave instruction code as a result of an instruction “exec”. Here, instructions “wait” are executed in #003 and #006 because if the zeroth slave instruction code is executed before the instructions “push” are completed in #000 to #002 and #005 (i.e., memory data has not been stored in registers), processing is performed using wrong data.

In order to prepare for next processing operations, in #008 to #011, data at other memory addresses is written to registers of the zeroth and first cores 140-0 and 140-1 as a result of instructions “push”. These registers are not used for the zeroth slave instruction code and used for a first slave instruction code to be executed after the zeroth slave instruction code is completed.

The zeroth slave instruction code is then completed for the zeroth and first cores 140-0 and 140-1. Completion of the instructions “push” for the first slave instruction code is waited for, and then the first and zeroth cores 140-0 and 140-1 are instructed to execute the first slave instruction code and obtain a result of the processing of the zeroth slave instruction code. More specifically, in #012 and #013, completion of the prior instructions for the zeroth core 140-0 is ensured. In #014, the zeroth core 140-0 is instructed to execute the first slave instruction code, and in #015, a result of the processing of the zeroth slave instruction code is written back at a memory address 0x0010. Similarly, in #016 and #017, completion of the prior instructions for the first core 140-1 is ensured. In #018, the first core 140-1 is instructed to execute the first slave instruction code, and in #019, the result of the processing of the zeroth slave instruction code is written back at a memory address 0x0014.

Lastly, in #020, completion of the first slave instruction code is waited for. In #021 and #022, result data is written back to the memory 101, and in #023, the processing is completed and the host device 102 is notified of the completion.

FIG. 8B illustrates an example of the zeroth slave instruction code to be executed by the processing instruction control unit 141. In the zeroth instruction code, in #000, a result obtained by adding data values of zeroth and first registers together is written to a third register. Next, in #001, a result obtained by multiplying data values of the second and third registers is written to a seventh register, and in #002, the processing is completed and the instruction control unit 110 is notified of the completion.

FIG. 8C illustrates an example of the first slave instruction code to be executed by the processing instruction control unit 141. In the first slave instruction code, in #000, a result obtained by subtracting a data value of a ninth register from a data value of an eighth register is written to a b-th register. Next, in #001, whether a value of the b-th register is equal to or larger than 0 is determined, and if so, multiplication in #004 is performed and the processing is completed in #005 while skipping rows #002 and #003. If the value of the b-th register is smaller than 0, on the other hand, multiplication in #002 and performed and the processing is completed in #003.

A control unit relating to execution of load instructions and store instructions for managing the memory bus is thus separated from the processing instruction control unit 141 of each core, that is, the instruction control unit 110 singlehandedly manages memory access. By intensively describing memory access instructions for all the cores 140 and controlling the memory access instructions using the instruction control unit 110, memory bus control can be performed and memory access performance can be improved while suppressing bus contention and overlap of read data. By including the processing instruction control unit 141 in each of the cores 140, the cores 140 can perform different processing operations (e.g., complex processing operations including branch instructions), and the processing operations can be performed without impairing parallelism.

An example has been described in which the host device 102 stores an instruction code in the instruction buffer of the instruction control unit 110 or the processing instruction control unit 141 in advance and then operations start. A instruction code to be handled is small enough to be stored in an instruction buffer, but when a mechanism for storing an instruction code in a memory and reading the instruction code to the instruction buffer as appropriate is provided, a larger instruction code can be executed.

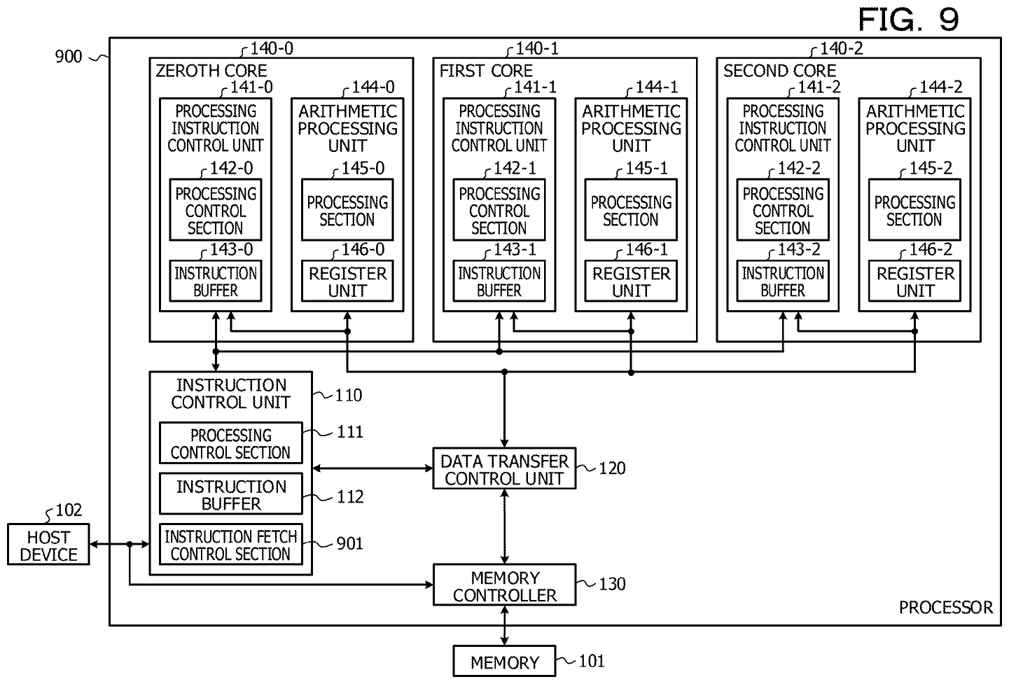

FIG. 9 illustrates an example of an information processing apparatus. In FIG. 9, components having the same functions as those of the components illustrated in FIG. 1 are given the same reference numerals, and redundant description thereof is omitted. In a processor 900 according to a second embodiment, the instruction control unit 110 includes an instruction fetch control section 901 as well as the processing control section 111 and the instruction buffer 112.

The instruction fetch control section 901 identifies a memory address at which an instruction code is stored and, after all instructions stored in an instruction buffer are executed, reads the instruction code from the memory 101 through the data transfer control unit 120 and stores the instruction code in the instruction buffer. As a result, the instruction control unit 110 can obtain an instruction code from the memory 101 as appropriate and handle an instruction code too large for the instruction buffer to store.

In FIG. 9, the following instruction “pushc” is added to the instruction set of the instruction control unit 110 illustrated in FIG. 1,
pushc <memory address><code number><core number>

The instruction “pushc” is used to read data having a certain data length (e.g., 256 bytes) from a specified memory address and write the data to an instruction buffer of a specified core as an instruction code having a specified code number.

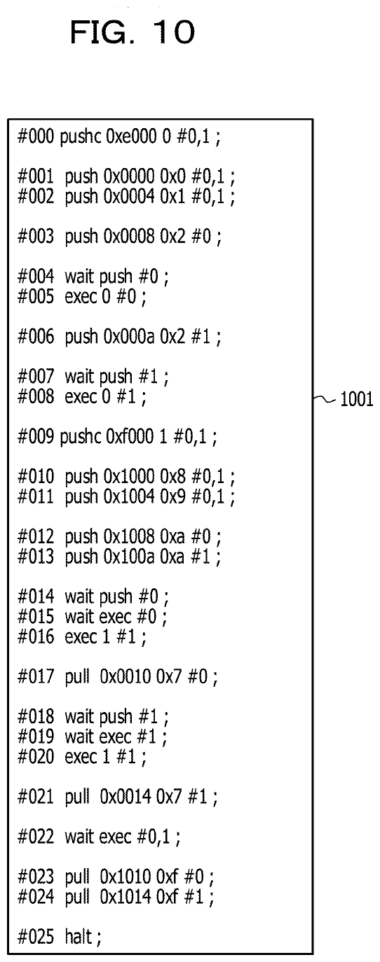

FIG. 10 illustrates an example of an instruction code. FIG. 10 is a diagram illustrating an example of a master instruction code to be executed by the instruction control unit 110. The master instruction code illustrated in FIG. 10 is different from the master instruction code illustrated in FIG. 8A in that 256-byte data is read from a memory address #0xe000 and stored in the instruction buffers 143 of zeroth and first cores 140-0 and 140-1 as a zeroth instruction code in #000 and in that 256-byte data is read from a memory address #0xf000 and stored in the instruction buffers 143 of the zeroth and first cores 140-0 and 140-1 as a first slave instruction code in #009. Since the instruction “pushc” is used, the processing instruction control unit 141 can receive a slave instruction code from the instruction control unit 110 and execute an instruction code too large for an instruction buffer to store.

The instruction control unit 110 and the data transfer control unit 120 control writing of data from the cores 140 to the memory 101 and reading of data from the memory 101 to the cores 140. A method may be employed, instead, in which the cores 140 directly transfer data to one another without performing reading and writing involving the memory 101. For example, a function of transferring data between the cores 140 without using the memory 101 is provided. In this case, when a user desires to use a result of processing performed by a core in another core, for example, the result does not have to be transmitted to the memory 101, which improves transfer latency.

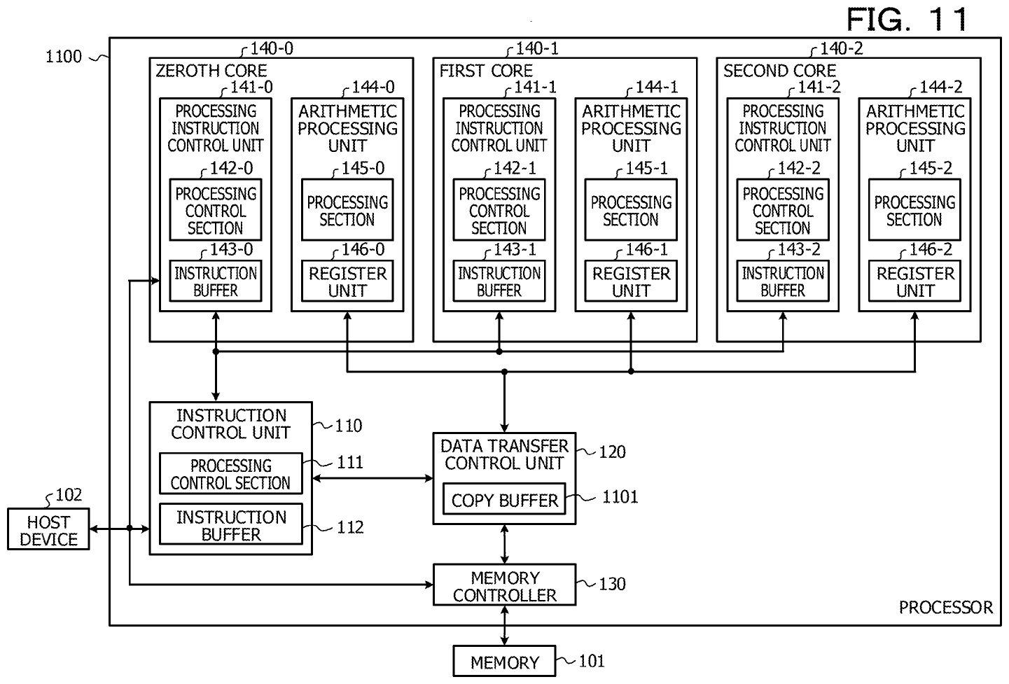

FIG. 11 illustrates an example of an information processing apparatus. In FIG. 11, components having the same functions as those of the components illustrated in FIG. 1 are given the same reference numerals, and redundant description thereof is omitted. In a processor 1100 according to a third embodiment, the data transfer control unit 120 includes a copy buffer 1101. The copy buffer 1101 holds data read from one of the registers of the register unit 146 of a core 140 when the data is to be written to one of the registers of the register unit 146 of another core 140.

In FIG. 11, the following instruction “copy” is added to the instruction set of the instruction control unit 110 illustrated in FIG. 1.
copy <register number 1><register number 2><core number 1><core number 2>.

The instruction “copy” is used to copy data from a register of a core specified by register number 1 and core number 1 to a register of a core specified by register number 2 and core number 2.

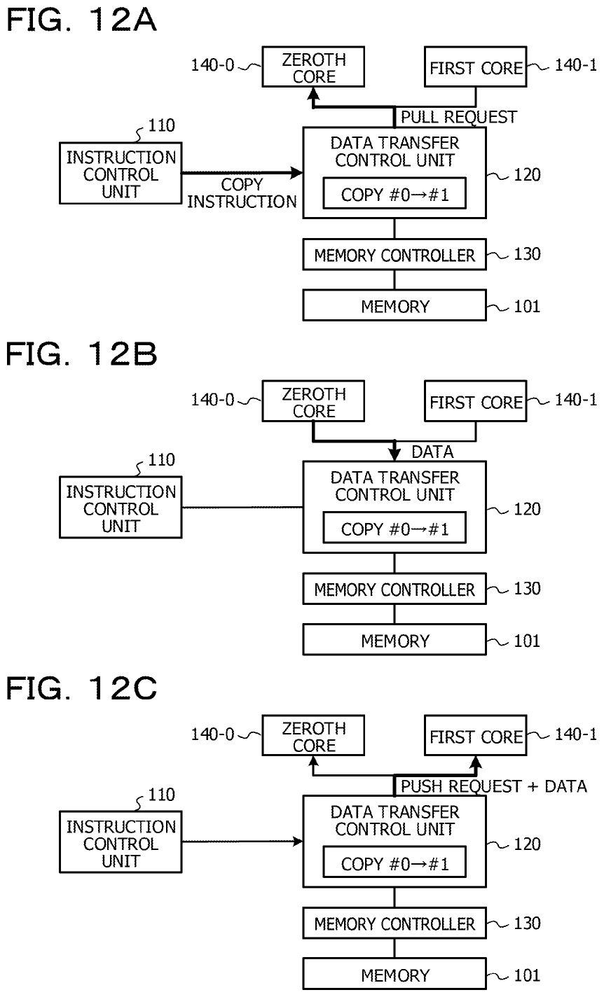

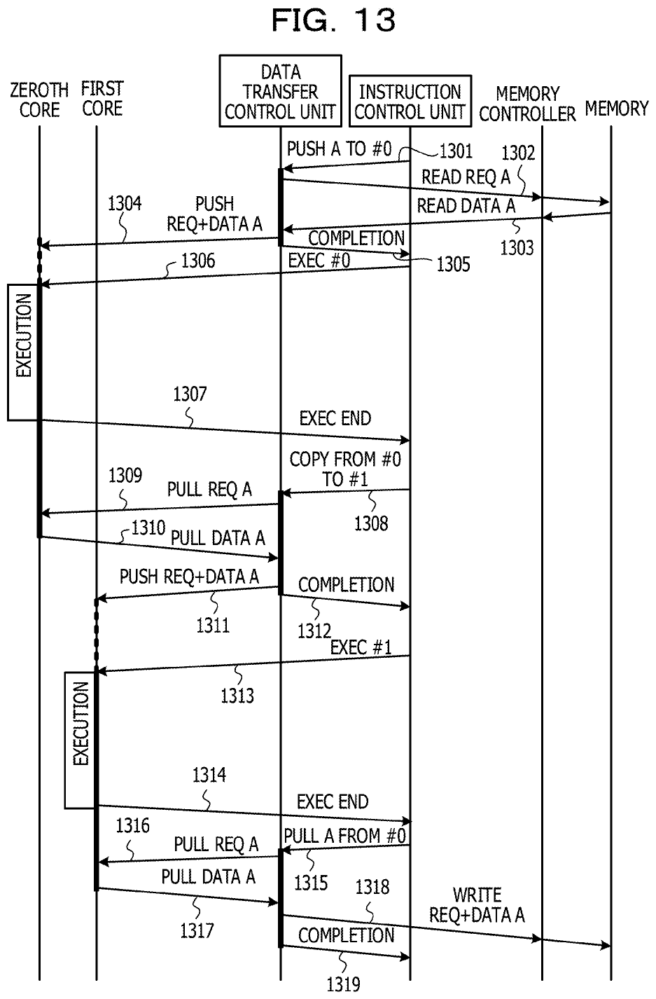

FIGS. 12A to 12C illustrate an example of an operation for copying data using the instruction “copy”. FIGS. 12A to 12C are diagrams illustrating an example of an operation for copying data from a register of the zeroth core 140-0 to a register of the first core 140-1 using the instruction “copy”. FIG. 13 illustrates an example of an operation performed by the information processing apparatus illustrated in FIG. 11. As illustrated in FIGS. 12A and 12B, the instruction control unit 110 executes the instruction “copy” to copy data from the register of the zeroth core 140-0 to the register of the first core 140-1, the data transfer control unit 120 reads data from the register of the zeroth core 140-0 (1308 to 1310 illustrated in FIG. 13), The data transfer control unit 120 stores the data read from the register of the zeroth core 140-0 in the copy buffer 1101. As illustrated in FIG. 12C, the data transfer control unit 120 writes the data stored in the copy buffer 1101 to the first core 140-1 (1311 illustrated in FIG. 13).

When the data is transferred from the register of the zeroth core 140-0 to the register of the first core 140-1, the data can be copied at high speed since the memory controller 130 is not accessed. Alternatively, instead of providing the copy buffer 1101 for the data transfer control unit 120, the data transfer control unit 120 may copy data read from the zeroth core 140-0 by immediately transferring the data to the first core 140-1 without holding the data. In this case, circuits used to achieve the copy buffer 1101 can be omitted.

Division reading (split push), in which a large data block collectively read from the memory 101 is divided and distributed to a plurality of cores, and combination writing (merge pull), in which pieces of data from different cores are combined as a large data block and collectively written to the memory 101, may be performed. For example, data units communicated through a memory access interface are larger than the size of a register file of each core. If small data is read and written, the use efficiency of the bus decreases. By performing division reading and combination writing of memory data, therefore, the use efficiency of the bus improves.

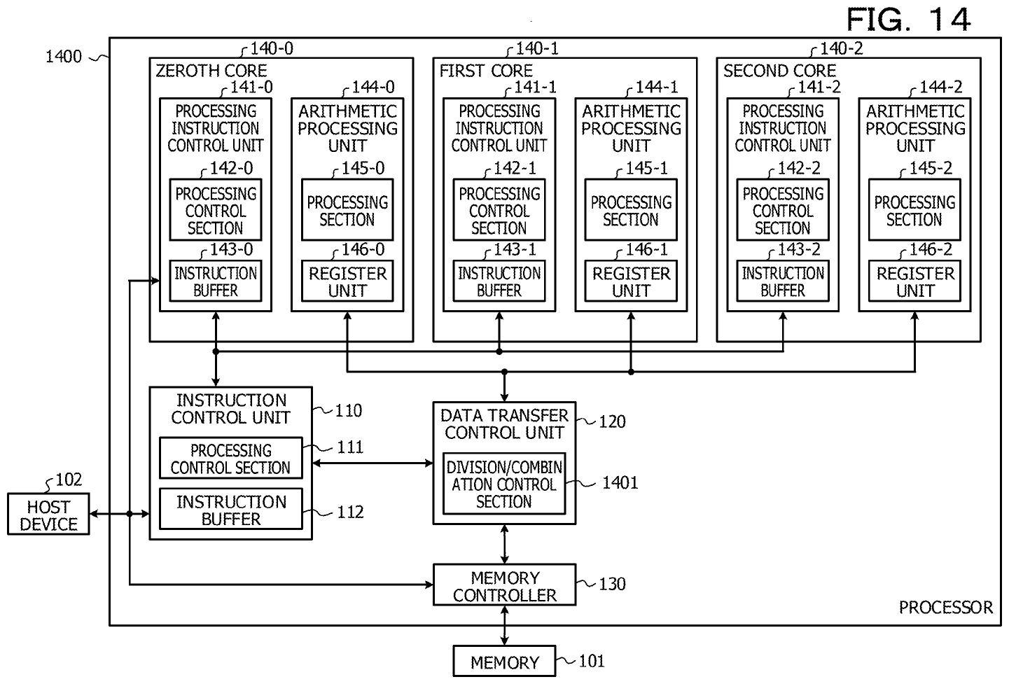

FIG. 14 illustrates an example of an information processing apparatus. In FIG. 14, components having the same functions as those of the components illustrated in FIG. 1 are given the same reference numerals, and redundant description thereof is omitted. In a processor 1400 according to a fourth embodiment, the data transfer control unit 120 includes a division/combination control section 1401. The division/combination control section 1401 divides data read from the memory 101 into upper bits and lower bits and transfers the upper bits and the lower bits to the zeroth and first cores 140-0 and 140-1, respectively. The division/combination control section 1401 also combines data read from the zeroth and first cores 140-0 and 140-1 with each other and issues the data to the memory controller 130 as a write request to a memory.

In FIG. 14, the following instructions “pushs” and “pullm” are added to the instruction set of the instruction control unit 110 illustrated in FIG. 1.
pushs <memory address><register number 1><register number 2><core number 1><core number 2>

The instruction “pushs” is used to read 8-byte data from a specified memory address and write upper 4 bytes to a register of a core specified by register number 1 and core number 1 and lower 4 bytes to a register of a core specified by register number 2 and core number 2
pullm <memory address><register number 1><register number 2><core number 1><core number 2>

The instruction “pullm” is used to read 4-byte data from each of registers of cores specified by register numbers 1 and 2 and core numbers 1 and 2, combine the 4-byte data as 8-byte data with the data from the register of the core specified by register number 1 and core number 1 set as upper bits, and writes the 8-byte data to a specified memory address.

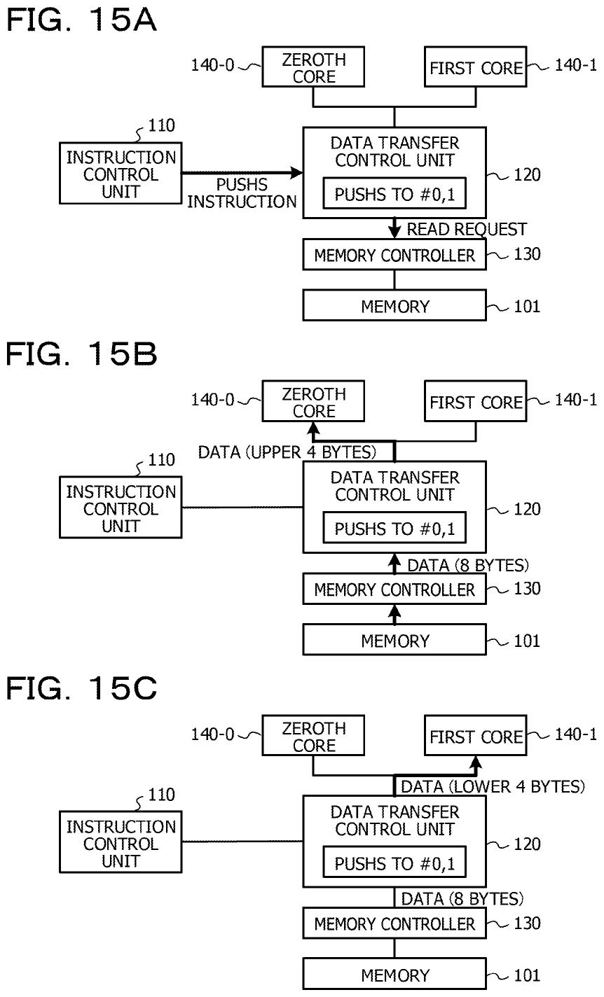

FIGS. 15A to 15C illustrate an example of an operation for transferring data using the instruction “pushs”. FIGS. 15A to 15C are diagrams illustrating an example of an operation for transferring data from the memory 101 to the zeroth and first cores 140-0 and 140-1 using the instruction “pushs”. As illustrated in FIG. 15A, the instruction control unit 110 executes the instruction “pushs” to transfer data to the zeroth and first cores 140-0 and 140-1, and the data transfer control unit 120 reads 8-byte data from the memory 101. The division/combination control section 1401 of the data transfer control unit 120 divides the data into upper 4-byte data and lower 4-byte data and transfers the upper 4-byte data to the zeroth core 140-0 as illustrated in FIG. 15B and the lower 4-byte data to the first core 140-1 as illustrated in FIG. 15C. This is just an example, and the division/combination control section 1401 may transfer the upper 4-byte data to the zeroth core 140-0 after transferring the lower 4-byte data to the first core 140-1.

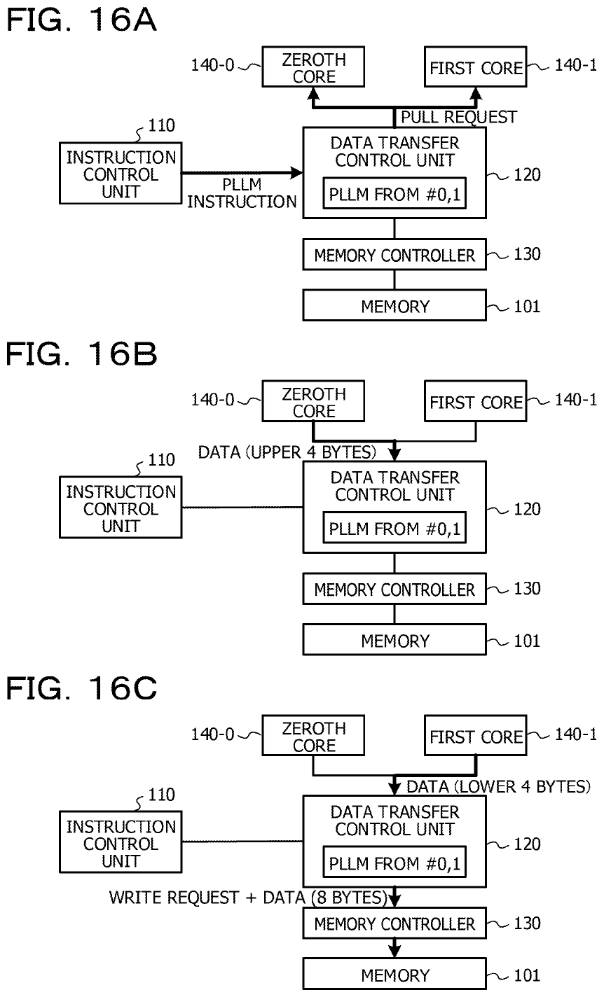

FIGS. 16A to 16C illustrate an example of an operation for transferring data using the instruction “pullm”. FIGS. 16A to 16C are diagrams illustrating an example of an operation for transferring data from the zeroth and first cores 140-0 and 140-1 to the memory 101 using the instruction “pullm”. As illustrated in FIG. 16A, the instruction control unit 110 executes the instruction “pullm” to transfer data from the zeroth and first cores 140-0 and 140-1, and the data transfer control unit 120 issues a pull request to the zeroth and first cores 140-0 and 140-1. As illustrated in FIGS. 16B and 16C, the data transfer control unit 120 reads 4-byte data from the zeroth and first cores 140-0 and 140-1. The division/combination control section 1401 of the data transfer control unit 120 then combines these pieces of 4-byte data as 8-byte data with the data from the zeroth core 140-0 set as upper bits and transfers the 8-byte data to the memory controller 130 as a write request. This is just an example, and the data transfer control unit 120 may read the data from the zeroth core 140-0 after reading the data from the first core 140-1.

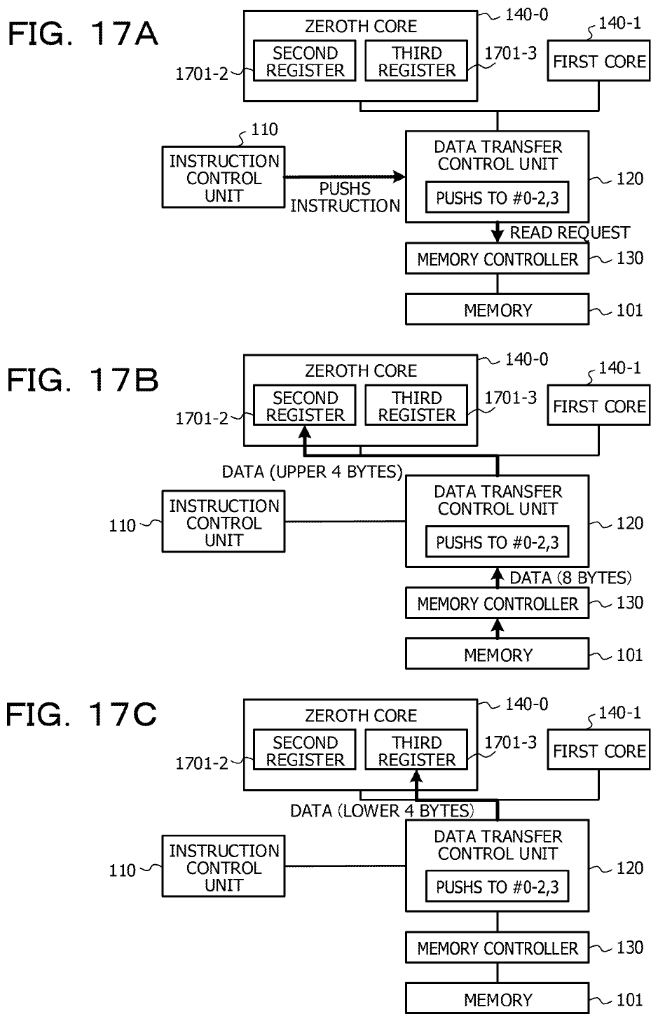

FIGS. 17A to 17C illustrate an example of an operation for transferring data using the instruction “pushs”. FIGS. 17A to 17C are diagrams illustrating an example of an operation for transferring data from the memory 101 to two different registers of the zeroth core 140-0. As illustrated in FIG. 17A, the instruction control unit 110 executes the instruction “pushs” while specifying second and third registers of the zeroth core 140-0, for example, and the data transfer control unit 120 reads 8-byte data from the memory 101. The division/combination control section 1401 of the data transfer control unit 120 divides the 8-byte data into upper 4-byte data and lower 4-byte data and transfers the upper 4-byte data to the second register of the zeroth core 140-0 as illustrated in FIG. 17B and the lower 4-byte data to the third register of the zeroth core 140-0 as illustrated in FIG. 17C. That is, when a target of division reading or combination writing is a plurality of registers of a core, the same processing as when the target is a plurality of cores can be performed. This is just an example, and the division/combination control section 1401 may transfer the upper 4-byte data to the second register after transferring the lower 4-byte data to the third register.

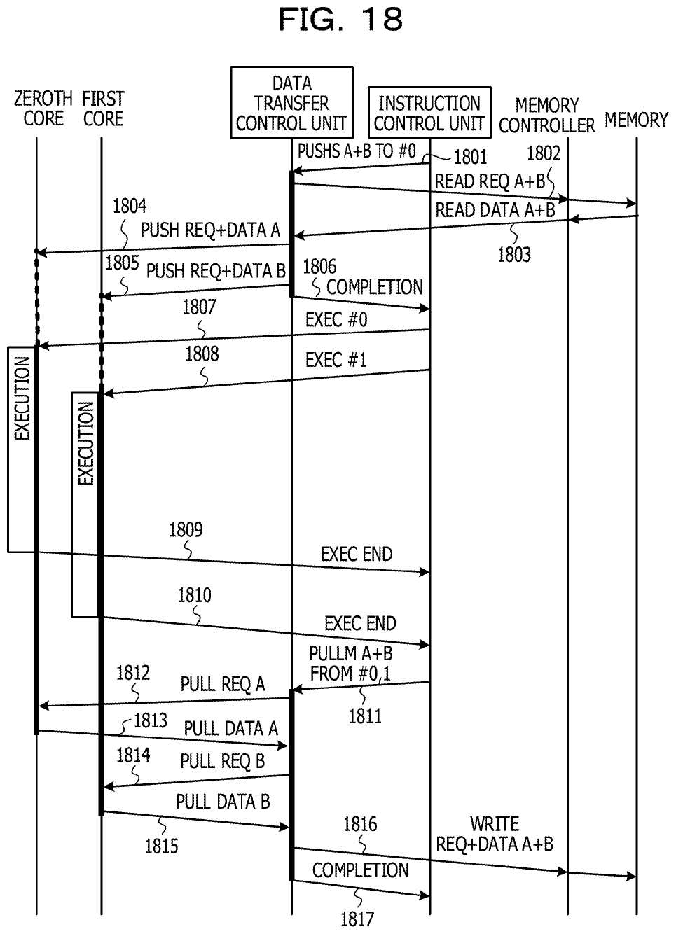

FIG. 18 illustrates an example of an operation performed by an information processing apparatus illustrated in FIG. 14. FIG. 18 illustrates an example of a procedure of an operation for performing division reading and combination writing of the memory data. By performing division reading and combination writing of memory data, data A and B to be transferred between the cores 140 and the data transfer control unit 120 can be processed by a single read or write request to the memory 101. As a result, the use efficiency of the bus between the memory controller 130 and the memory 101 improves.

Data sizes to be used are not limited to 4 bytes and 8 bytes. For example, division and combination may be performed with larger data sizes such as 32 bytes and 64 bytes. In addition, memory data does not have to be equally divided for cores. For example, 8 bytes out of 32 bytes may be transferred to the zeroth core 140-0, and remaining 24 bytes may be transferred to the first core 140-1. Furthermore, division and combination do not have to be performed between two cores, and, for example, 32-byte memory data may be divided into four pieces and transferred to zeroth to third cores.

In general, in a processor (arithmetic processing device) including a plurality of cores, a large number of transistors simultaneously begin to operate when processing starts. Switching noise, therefore, might be caused due to large current and trigger a malfunction. This can be avoided by causing the cores of the device to begin to operate at different timings. For example, zeroth and first cores 140-0 and 140-1 are adjusted in such a way as not to execute an instruction “exec” at the same time, in order to suppress switching noise.

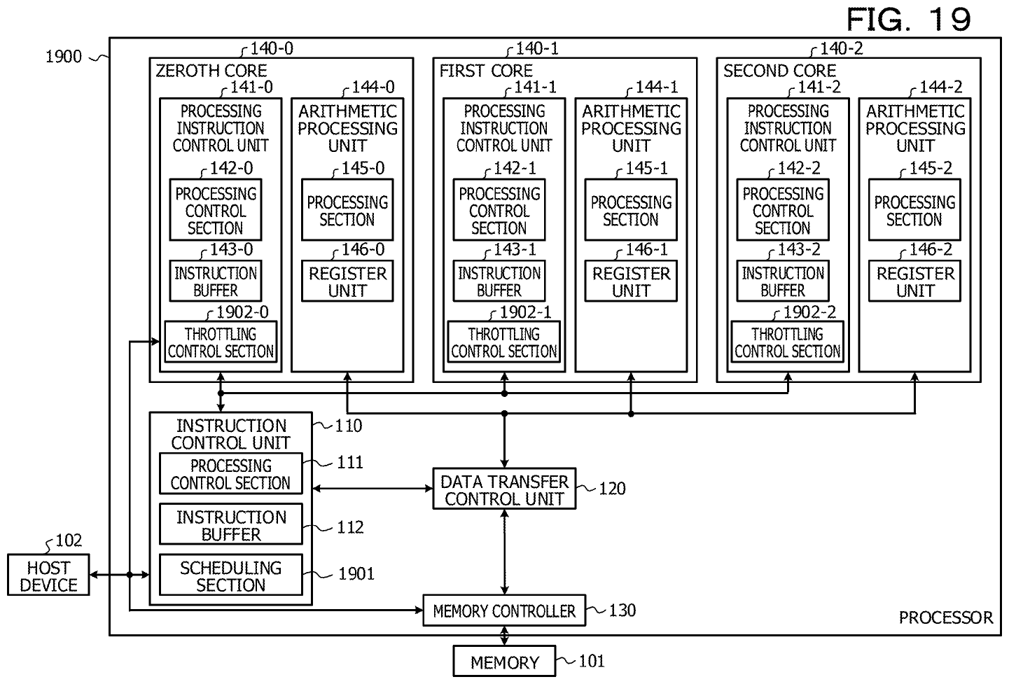

FIG. 19 illustrates an example of an information processing apparatus. In FIG. 19, components having the same functions as those of the components illustrated in FIG. 1 are given the same reference numerals, and redundant description thereof is omitted. In a processor 1900, the instruction control unit 110 includes a scheduling section 1901 as well as the processing control section 111 and the instruction buffer 112. The processing instruction control unit 141 includes a throttling control section 1902 as well as the processing control section 142 and the instruction buffer 143.

When an instruction “exec” has been executed for a core 140, the scheduling section 1901 begins to count time and does not allow the execution of a next instruction “exec” until a certain period of time elapses. The certain period of time may be set by software through a control register or the like. Since the scheduling section 1901 of the instruction control unit 110 secures minimum execution intervals of instructions “exec”, a plurality of cores do not simultaneously start processing, and switching noise caused by simultaneous starting of processing by a plurality of cores is reduced.

The throttling control section 1902 changes the throughput of the processing control section 142 in accordance with an instruction from the instruction control unit 110. The processing control section 142 can usually process one row of an instruction in one cycle, for example, and the throttling control section 1902 adjusts the processing control section 142 such that the processing control section 142 processes one row in two or three cycles. When the throttling control section 1902 adjusts the processing control section 142 such that the processing control section 142 executes one instruction in two cycles at a beginning of processing and, after a certain period of time elapses, executes one instruction in one cycle, for example, a change in current at the beginning of processing becomes small, and switching noise caused by simultaneous starting of the operation by processing sections of cores is reduced.

In order to achieve this type of control, in FIG. 19, the following instruction “throttle” is added to the instruction set of the instruction control unit 110 illustrated in FIG. 1.
throttle <number of cycles><core number>

The instruction “throttle” is used to instruct the throttling control section 1902 of a specified core to process an instruction in one row in a specified number of cycles.

An instruction to perform throttling control can be achieved not as an instruction from the instruction control unit 110 but as an instruction from the processing instruction control unit 141. For example, when the instruction control unit 110 that is controlling the instructions “push”, “pull” and “exec” relating to the cores 140 can overlook processing states of the cores 140 and execute instructions to perform throttling control, more effective control can be performed.

For example, arithmetic processing devices used in fields of basic technologies might have a function of continuing to operate until maintenance work is performed even in the case of a failure. For example, one of cores included in a processor is determined as a spare core in order to provide redundancy and make it possible to continue to operate even in the case of a failure.

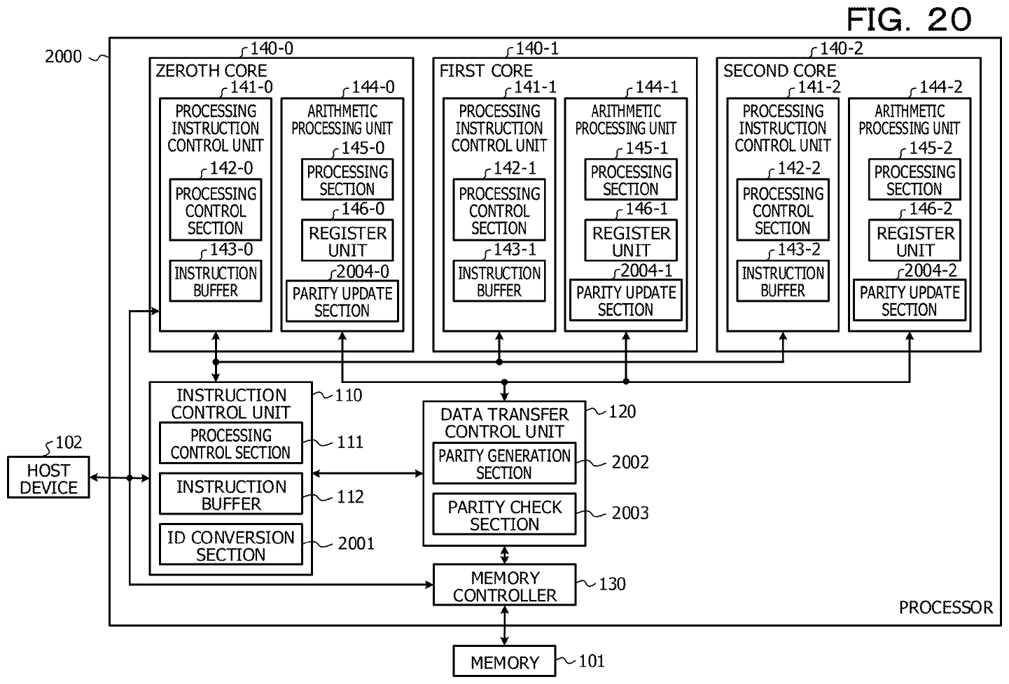

FIG. 20 illustrates an example of an information processing apparatus. In FIG. 20, components having the same functions as those of the components illustrated in FIG. 1 are given the same reference numerals, and redundant description thereof is omitted. In a processor 2000 according to a sixth embodiment, the instruction control unit 110 includes an identifier (ID) conversion section 2001 as well as the processing control section 111 and the instruction buffer 112. The data transfer control unit 120 includes a parity generation section 2002 and a parity check section 2003. The arithmetic processing unit 144 includes a parity update section 2004 as well as the processing section 145 and the register unit 146. In the processor 2000 according to the sixth embodiment, the second core 140-2 is determined as a spare core for the zeroth and first cores 140-0 and 140-1.

When reading data from the memory 101 using an instruction “push”, the data transfer control unit 120 causes the parity generation section 2002 to add a 1-bit parity checksum for each set of 8-bit data and transfers the data to the register unit 146 of a core 140. The core 140 that has received the data from the data transfer control unit 120 holds the checksum and causes the parity update section 2004 to update the checksum in accordance with a result of processing performed by the processing section 145.

After the processing is completed, the data transfer control unit 120 causes, when reading data from a core 140 using an instruction “pull”, the parity check section 2003 to check whether the checksum is correct. If an error is detected as a result of the check, the data transfer control unit 120 notifies the instruction control unit 110 of a number of the core 140 that has transmitted the data as failure information. With this mechanism, a failure of a core can be detected during operation.

The ID conversion section 2001 converts a core number (logical ID) specified by a master instruction code into a physical core number (physical ID) of hardware. In a normal state before a failure occurs, both the zeroth and first cores 140-0 and 140-1 are operating normally, and the second core stands by as a spare core. The ID conversion section 2001, therefore, converts a zeroth logical ID into a zeroth physical ID and a first logical ID into a first physical ID and executes instructions. That is, the ID conversion section 2001 transfers data to the zeroth and first cores 140-0 and 140-1 and instructs the zeroth and first cores 140-0 and 140-1 to execute instructions while using core numbers described in a master instruction code.

If the zeroth core 140-0 fails due to deterioration during operation or an initial defect and the instruction control unit 110 detects the failure, for example, the ID conversion section 2001 converts the zeroth logical ID into a second physical ID and the first logical ID into the first physical ID. That is, an instruction for which the zeroth core 140-0 is specified in a master instruction code is actually executed by the second core. By converting a core number in an instruction code into a spare core number when a failure of a core has been detected, operation can continue using a spare core instead of the failed core.

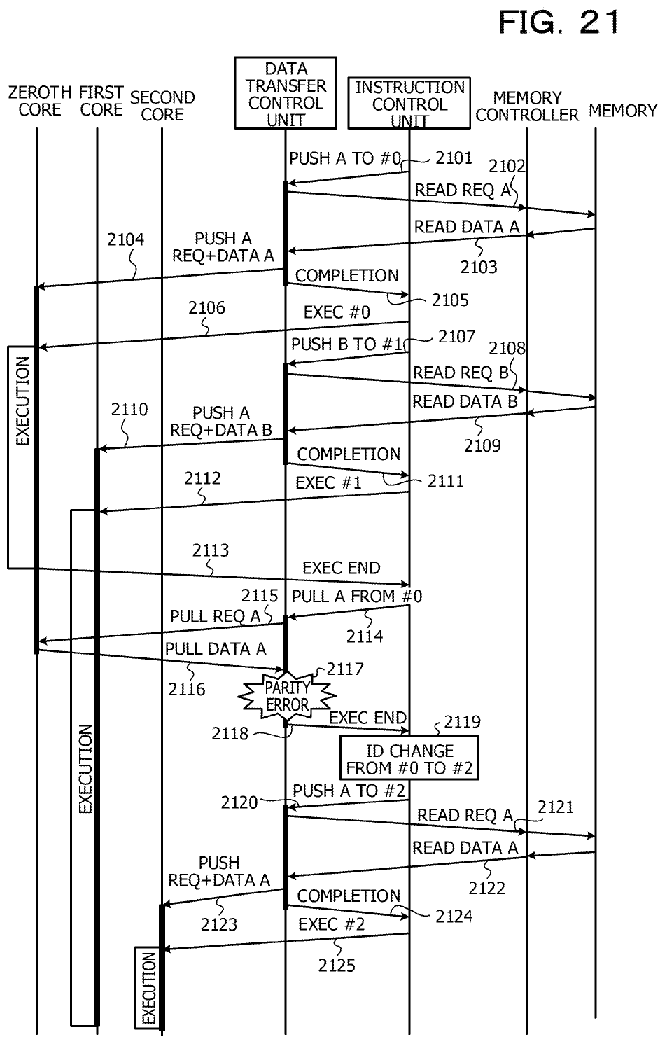

FIG. 21 illustrates an example of an operation performed by the information processing apparatus illustrated in FIG. 20. FIG. 21 illustrates an example of a procedure of an operation for detecting a failure and switching a core in FIG. 20, In FIG. 21, an error in a parity checksum is detected in data A processed by the zeroth core 140-0 (2117), and logical-to-physical ID conversion is performed so that the zeroth logical ID of the zeroth core 140-0, which is being instructed by the instruction control unit 110, is converted into the second physical ID and the data transfer control unit 120 issues instructions to the second core (2119). After the switching to the second core, the reading of data A, in which the parity error has been detected, is retried in order to continue to process instructions.

Although a method in which a parity checksum is added to data has been described as a method for detecting a failure, another failure detection mechanism may be used, instead. For example, a built-in self-test (BIST) circuit or the like that automatically scans register files of each core after the device is turned on may be separately provided.

For example, mirroring, in which a plurality of cores synchronously perform exactly the same processing and a failure is detected by comparing results of the processing, may be performed.

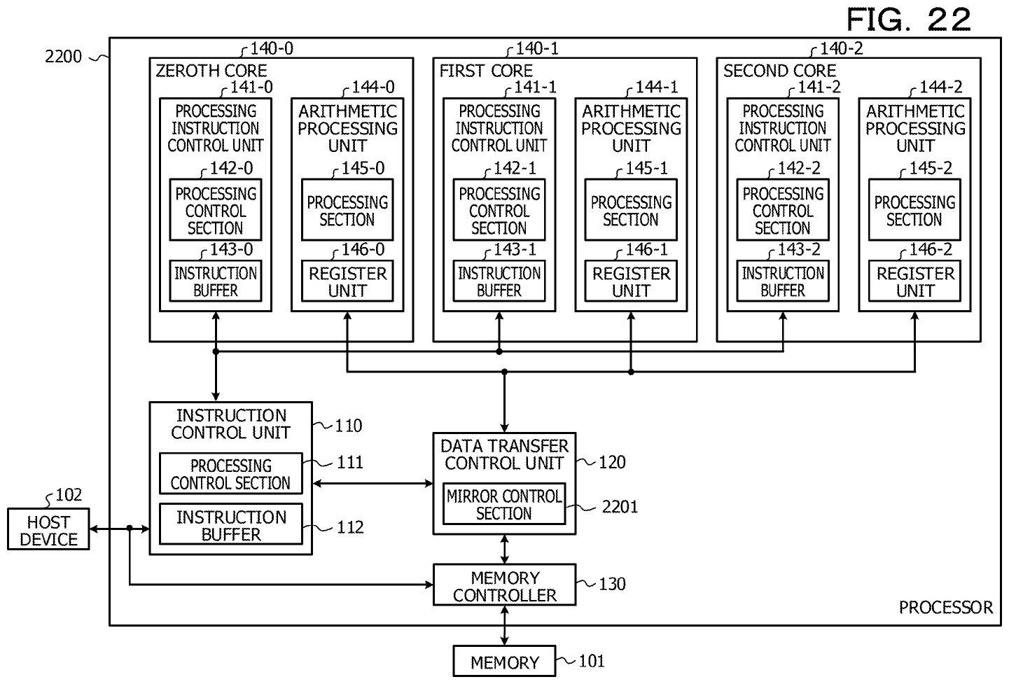

FIG. 22 illustrates an example of an information processing apparatus. In FIG. 22, components having the same functions as those of the components illustrated in FIG. 1 are given the same reference numerals, and redundant description thereof is omitted. In a processor 2200, the data transfer control unit 120 includes a mirror control section 2201.

The mirror control section 2201 includes a register capable of enabling or disabling an mirror operation through software and has a function of, when the mirror operation is enabled, copying instructions issued to the zeroth core 140-0 from the instruction control unit 110 and causing the first and second cores 140-1 and 140-2 to execute the instructions. When an instruction “pull” has been copied and data has been read from the zeroth and first cores 140-0 and 140-1, the mirror control section 2201 checks whether values of the data are the same.

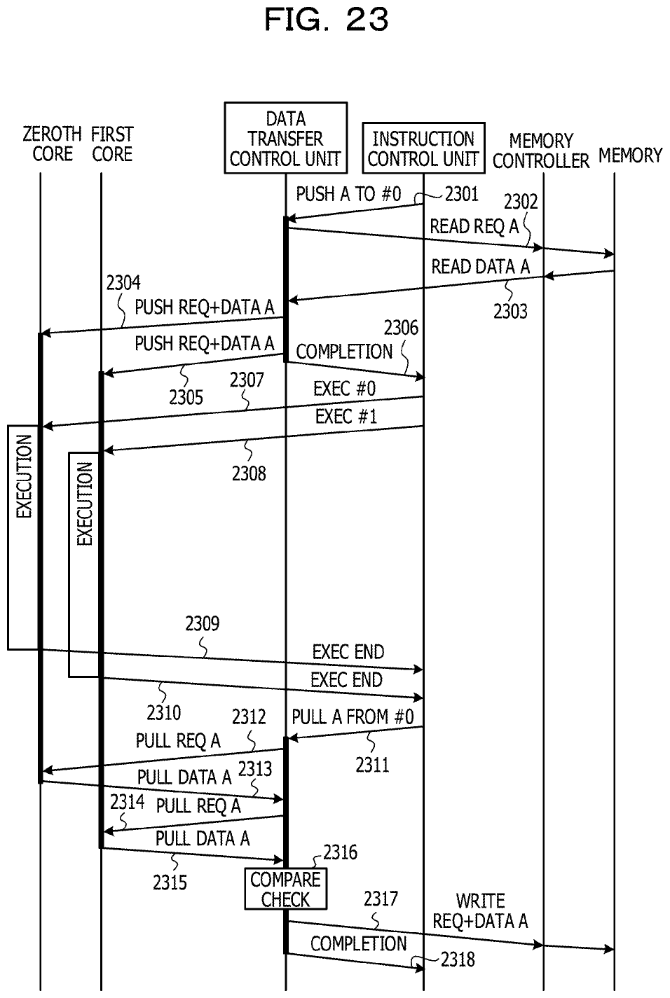

FIG. 23 illustrates an example of an operation performed by the information processing apparatus illustrated in FIG. 22. FIG. 23 illustrates an example of a procedure of an operation for performing core mirroring. As illustrated in FIG. 23, when the instruction control unit 110 has issued an instruction to the zeroth core 140-0, the data transfer control unit 120 copies the instruction and causes the first core 140-1 to execute the instruction. In addition, when data has been read from the zeroth and first cores 140-0 and 140-1 using instructions “pull”, the data transfer control unit 120 compares values of the data (2316) and writes the data to the memory 101 after checking that the values of the data are the same. By operating the first core 140-1 as a copy of the zeroth core 140-0 and comparing results of processing performed by the zeroth and first cores 140-0 and 140-1, a possible malfunction of the zeroth core 140-0 or the first core 140-1 due to a failure can be immediately detected.

The number of cores used for mirror operation does not have to be two. For example, it is assumed that three cores are used for mirror operation. If one of the cores fails and results obtained by executing instructions “pull” become different from one another, the failed core can be immediately identified by the decision of the majority.

Although the topology of a memory bus is a star network based on the memory controller 130 in the above embodiments, the topology of a memory bus is not limited to this. For example, a ring network, in which cores are connected to one another in a row, may be employed for a memory bus, instead. Although the instruction control unit 110 and the processing instruction control unit 141 execute an instruction without waiting for the completion of a previous instruction unless there is an instruction “wait” in the above embodiments, sequential operation, in which the instruction control unit 110 and the processing instruction control unit 141 execute an instruction after a previous instruction is completed, may be employed, instead.

Instructions defined as an instruction set of the instruction control unit 110 are not limited to those described above, and an instruction to perform type conversion and an instruction to process data may also be supported. The following instruction “pushi”, for example, may be added.
pushi <memory address><register number><core number>

The instruction “pushi” is used to read 4-byte data from a specified memory address, convert the 4-byte data from a floating-point type (float type) into an integer type (int type), and write the 4-byte data to a specified register of a specified core. The above embodiments do not have to be independently implemented and may be combined with one another.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An arithmetic processing device comprising:
a memory controller that accesses a main storage device;
a plurality of arithmetic processing cores that execute instructions;
an instruction controller that controls execution of an access instruction to load and store data in the plurality of arithmetic processing cores from and to the main storage device;
a transfer controller that:
controls data transfer between the memory controller and the plurality of arithmetic processing cores in accordance with an instruction from the instruction controller; and
divides data read from the main storage device with a single request into first data to be supplied to a first arithmetic processing core of the plurality of arithmetic processing cores and second data to be supplied to a second arithmetic processing core of the plurality of arithmetic processing cores and supplies the first and second data.

2. An information processing apparatus comprising:
a main storage device that stores data; and
an arithmetic processing device coupled to the main storage device,
the arithmetic processing device includes:
a memory controller that accesses the main storage device;
a plurality of arithmetic processing cores that execute instructions;
an instruction controller that controls execution of an access instruction to load and store data in the plurality of arithmetic processing cores from and to the main storage device; and
a transfer controller that:
controls data transfer between the memory controller and the plurality of arithmetic processing cores in accordance with an instruction from the instruction controller; and
divides data read from the main storage device with a single request into first data to be supplied to a first arithmetic processing core of the plurality of arithmetic processing cores and second data to be supplied to a second arithmetic processing core of the plurality of arithmetic processing cores and supplies the first and second data.
